(19) United States
(12) Patent Application Publication
(10) Pub. No.: US 2015/0262304 A1
(43) Pub. Date: Sep. 17, 2015

(54) Obligatory Methods And Systems For Generating Funds for Retirement And Special Needs

(71) Applicant: Victor Eli Velazquez-Gonzalez, Humacao, PR (US)

(72) Inventor: Victor Eli Velazquez-Gonzalez, Humacao, PR (US)

(21) Appl. No.: 14/204,496

(22) Filed: Mar. 11, 2014

(51) Int. Cl. G06Q 40/06; G06Q 40/00

(52) U.S. Cl. CPC G06Q 40/06; G06Q 40/10

(57) ABSTRACT

The present invention comprises an obligatory method and system for accumulating an amount of money for retirement or for special needs. Everyone repeatedly purchases goods and services. The invention comprises automatically placing an amount of money into an account, which amount of money is a percent of the amount of the purchase of a good or a service. The amount of money is paid by the purchaser and is placed in said account for the benefit and use of said purchaser and/or for any designated beneficiary. The main object of the invention is to generate funds which the purchaser or beneficiary may use upon retirement, and/or for special needs, and/or in a catastrophic situation such as a certified disability.

### CROSS REFERENCE TO RELATED APPLICATIONS

There are no related applications by this inventor.

### BACKGROUND OF THE INVENTION

It is incumbent upon every citizen to make provision for his/her own retirement or special needs and those of their dependents. It is critical for individuals to generate sufficient present and future income for their own present and future needs and for the present and future needs of designated beneficiaries. Those individuals who cannot or do not make provision for the cost of retirement or of their special needs either end up doing without critical care and help, often with fatal or deleterious results, or become a burden of the government and the public dole.

To ensure financial security in retirement or to cover special needs, workers generally rely on: (1) savings, (2) a pension plan or purchased annuity; (3) sale and/or rent of real estate; (4) income generated by reported or unreported full-time or part-time employment, (5) insurance to cover unexpected losses or unexpected situations, and (6) Social Security.

However, the Employee Benefit Research Institute 2013 Retirement Confidence Survey Report shows that about 29 percent of American workers and retirees have no retirement account. About 79 percent of these individuals (that is, 22.9% of the total population) don't have accounts because they can't afford to save for retirement. Of those that do have savings, more than half of workers report they and/or their spouse have less than $25,000 in total savings and investments (excluding their home and defined benefit “DB” plans that pay a defined lifetime annuity), including 28 percent who have less than $1,000.

On the other hand, the percentage of workers covered by a traditional DB pension plan that pays a lifetime annuity, often based on years of service and final salary, has been steadily declining over the past 35 years. From 1980 through 2008, the proportion of private wage and salary workers participating in DB pension plans fell from 38 percent to 20 percent (Bureau of Labor Statistics). In contrast, the percentage of workers covered by a defined contribution (DC) pension plan—that is, an investment account established and often partly subsidized by employers, but owned and controlled by employees—has been increasing over time. From 1980 through 2008, the proportion of private wage and salary workers participating in only DC pension plans increased from 8 percent to 31 percent (Bureau of Labor Statistics 2008; Department of Labor 2002).

Gallup's annual Economy and Personal Finance survey reveals that in 2013, approximately 38% of Americans did not own a home. Eleven percent of Americans did not own a home and had no plans to buy one. The 38% who do not own homes cannot rely on real estate to solve their needs. And, even for the 62% who do own homes, the value of real estate has plummeted and mortgage foreclosures have exploded in the past decade due to the real estate and mortgage crisis. Thus, the property owners' ability to rely on their real estate equity has correspondingly diminished.

In 2013, about 18.6% (57.5 million persons) of the US population had no health insurance. People without health insurance had a 40 percent higher risk of death than those with health insurance. The amount people pay for health insurance increased 30 percent from 2001 to 2005, while income for the same period of time only increased 3 percent. Were it not for Medicare, many more, especially the elderly, would be uninsured.

In the past, the U.S. government has relied on Social Security as the main source of income for retired individuals, certain eligible minors, and eligible disabled individuals. Currently, Social Security is the sole source of income for 21% percent of all elderly Americans age 65 and older, and the primary source for two-thirds of all senior citizens.

However, since Social Security is derived from reported salaries obtained through gainful formal employment and from employer contributions, those who cannot or do not work and those who do not report or under-report their income, do not accrue and/or receive Social Security. The end result is that many elderly citizens receive insufficient income to cover their needs upon retirement. This includes many improvident individuals who generated sufficient income during their productive lifetime to adequately provide for retirement, but under-reported this income and/or spent it on goods and services, and did not make provision for their retirement.

The Social Security system is now in crisis, because of the aging of the US population (which results in proportionally fewer working age individuals contributing to SS at the same time that proportionally more individuals receive SS benefits) and the worldwide financial crisis (which has resulted in higher unemployment so fewer are contributing to SS). Social Security will cost more than it brings in by 2017. Making matters worse, the assets of the Old-Age and Survivors, and Disability Insurance Trust Funds which feed SS will be exhausted in 2037. The US Treasury will have to borrow to pay SS benefits when SS tax revenues are insufficient. There will be an explosion in the outstanding debt as baby boomers draw their maximum benefits. Other things equal, the peak level of the debt/Gross Domestic Product ratio during that period could be reduced only by increasing taxes from any source, reducing SS benefits, or increasing the growth rate of the Gross Domestic Product.

The above statistics reveal that a large proportion of Americans have limited resources available for retirement and to meet special needs, and that the rising cost of living coupled to the diminishing purchasing power makes things worse. In addition, an important segment of the population cannot or fails to adequately provide for retirement. Government and public funds obtained from provident taxpayers should not be expected to make up the shortfall caused by poor or improvident planning There is therefore a critical need for methods to stimulate and ensure that every individual maximizes their preparedness for retirement and for meeting their needs and those of their dependents, and to reduce the dependence on government programs (and the need for government programs).

### PRIOR ART

The closest prior art appears to be U.S. Pat. No. 5,991,736, currently expired for failure to pay maintenance fees (whose dispositions are incorporated by reference as prior art). That patent describes a voluntary patronage incentive system in which a monetary award is made by the seller to a purchaser's retirement account as incentive for the purchaser its sponsor for the sponsor's goods or services. The system includes a means for identifying the purchaser, a means for inputting the identification information and other information about the transaction into a computer data storage, a computer data processing device which uses a software program along with the transactional information to calculate an incentive award amount, a means for transferring the monetary funds to the purchaser's retirement account, and a means of reporting the incentive award amount to the purchaser and to the seller.

U.S. Pat. No. 7,120,592 describes a means whereby individual consumers and individual merchants can purchase all types of goods and services and take advantage of the savings brought about by volume purchasing of these goods, products and services. It is further envisioned that the savings realized by volume purchasing will be placed in consumer's retirement investing accounts thereby giving the consumer added funds for retirement and other purposes.

U.S. Pat. No. 8,126,796 describes a “System and method for automatically investing a portion of interest charged in a mortgage installment payment” wherein a percentage of a borrower's monthly home loan repayments to a loan provider is allocated to an interest payment account and an equity accrual account.

U.S. Pat. No. 8,321,318 describes a “System and method for facilitating the funding and administration of a long term investment or retirement trust” for a minor child or minor children. In one embodiment, that invention provides a system and method for the real-time, interactive, dynamic modeling and goal-solving for the pre-funding of a retirement benefit account specific to a minor child. In another embodiment, the present invention provides a system and method for the real-time production of trust documents necessary and specific to the purpose of establishing a funded pre-retirement trust for a minor child.

U.S. Pat. No. 8,429,052 describes a “Method and system for providing employer-sponsored retirement plan.” This patent describes a computer-implemented method of administering income distributions from an employer-sponsored retirement plan having a participant account value which provides an option to a plan participant to elect a lifetime payout funded by at least a portion of the participant's account value. The lifetime payout may be funded by a Plan Distributed Annuity (“PDA”) or through the plan. An access period may be provided in the latter case, during which a participant maintains access to, and control over, the account.

The inventions described in the above mentioned patents are voluntary. A business or individual purchaser may opt not to participate, and many will so opt. The mere fact that U.S. Pat. No. 5,991,736 issued in 1999 and certainly has not been implemented widely, if at all, indicates that the voluntary patronage system is not commercially successful. Thus, many of the purchases of goods and services made by individuals do not yield a benefit beyond the use and enjoyment of the purchased goods and services. In contrast, the obligatory nature of the present invention ensures that individuals benefit from the many daily purchases, over the course of a lifetime.

The prior art further includes Social Security and government implemented systems for assessing and collecting sales tax.

Social Security is in large part funded by withholding a portion of an employees' salary and transferring this amount to the government, and also by exacting a contribution from that employee's employer. The amount of payout from Social Security may exceed the amount each individual contributes, which places a burden on government to provide for any shortfalls. This is precisely why Social Security is in crisis. In the present invention, the amount withheld is based on the purchase of goods and services, the withheld amounts are solely for the benefit of the purchaser and his designated beneficiaries, and an individual receives no more than he/she pays in.

On the other hand, the sales tax requires that each seller of taxed goods and services faithfully retain and transmit to the government a percentage of the cost of the good and service. Even if the sales tax is accurately charged and transmitted, the amount that is collected does not directly benefit the consumer who pays the tax, since it is used to fund government activities, some of which the taxpayer may actually disapprove of The amount an individual may receive in benefits, if he/she receives anything at all, is a tiny fraction of the amount he/she is forced to contribute. Since there is no stimulus or tool for the taxpayer to monitor that the tax is actually transmitted to government, unscrupulous businesses may charge and illegally retain the tax. For example, in Puerto Rico it is estimated that 44% of the sales tax is retained and not reported or transmitted. The individual who pays the tax loses out on the taxed amount, but receives no benefit at all. And the government is cheated out of much needed revenue.

In addition, there are a number of financial instruments which enable individuals and business entities to put part of their income into tax-deferred accounts such as Individual Retirement Accounts, trusts, and 401(k) accounts. These are mostly voluntary, and none of these use money derived from purchases to fund a retirement account.

### BRIEF SUMMARY OF THE INVENTION

The present invention comprises an obligatory method and system for accumulating an amount of money for retirement or for special needs. Everyone ages and retires, and needs to provide for retirement. Many individuals have or develop special needs that must be met.

The present invention takes advantage of the fact that everyone is a consumer of goods and services. Over a lifetime, individuals may spend hundreds of thousands and many individuals spend millions of dollars in goods and services. The present invention comprises obligatorily and automatically placing an amount of money into an account. Said amount of money is determined as a percentage of the amount the purchaser spends on goods and/or services, and is paid by the purchaser. The money is placed in an account for the benefit and use of said purchaser and/or for any designated beneficiary. The main object of the invention is to generate funds which the purchaser may use for specific purposes, or in a catastrophic situation, or upon retirement.

Moreover, government agencies have a particular interest in monitoring individual spending habits and patterns, either to detect important individual, regional or nation-wide trends, or to monitor the spending habits of individuals or entities who may under-report their income, yet liberally spend that unreported income to purchase goods and services. The present invention provides a tool for gathering cumulative information about the myriad expenses of each individual and for monitoring the underground and/or informal economy and for detecting tax evasion. For example, the information gathered by the systems and methods of the present invention can be used to detect businesses that charge sales tax but do not report or transmit the tax. For example, approximately 44% of sales tax is charged but goes unreported in Puerto Rico, which translates to about $900 millions in annual lost much-needed revenue funds which are illegally pocketed by tax-evading businessmen.

### PREFERRED EMBODIMENT

Throughout their natural or corporate lifetime, individuals and legal entities repeatedly pay for goods and services, whose cost either yearly or over a lifetime (depending on individual income and spending habits) may amount to tens of thousands, even millions of dollars. Aside from occasional rebates and sales prices, the money spent in a year or in a lifetime yields no or few returns for the purchaser beyond the use and enjoyment of the purchased good or service.

The present invention comprises a method and system for obligatorily and automatically transferring an amount of money into an account. Said amount of money is paid by the purchaser and is determined as a percentage of the amount the purchaser spends on goods and/or services. The money is placed in an account for the benefit and use of said purchaser and/or for any designated beneficiary. The main object of the invention is to generate funds which the purchaser and/or a designated beneficiary may use for specific purposes, or in a catastrophic situation, or upon retirement.

The purchaser may be an individual or a legal entity such as a trust or a private business (for example, a restaurant that purchases produce or tables, cutlery, etc. from a distributor retailer or wholesaler). The purchaser may belong to the group that comprises a professional corporation, a government entity, and a for profit business.

In the case of a government entity which typically expends thousands and millions of dollars in purchasing goods and services, the government may be exempt from being charged a percent of the government's purchases. Alternatively, the government may be obligated to transfer a percentage of the value of its purchases to accounts that include government employee pension plan accounts, teacher's pension plan accounts, and/or accounts that benefit veterans the aging, and/or the disabled. More bang for the governmental buck.

The money generated as a percent of the sale and purchase of the good or service may be placed into an account for an individual purchaser, or for a beneficiary chosen by the purchaser.

The beneficiary may be the purchaser or a family member. The beneficiary may also be selected from the group comprising an individual, a non-profit organization, an employee, a business, a government entity, a friend, etc. The beneficiary may receive funds in the account only upon the death of a purchaser who was a natural person, or upon the dissolution of a purchaser who is not a natural person. The beneficiary may receive funds in the account only upon becoming a certified recipient of Social Security because of age or a disability. (If Social Security ceases to exist or if is not the entity that makes disability determinations, or if it becomes desireable not to follow Social Security's criteria, either a public or private entity, which may be a division of the entity that administers the account, may be created to evaluate, approve, disapprove, administer and authorize when a person may be eligible because of a disability.) Preferably, upon the death or dissolution of the purchaser, any funds in the account that are not consumed by funeral expenses are transferred to an account of the present invention which belongs to the beneficiary. The beneficiary may use the transferred funds upon retirement, for funeral expenses, upon receiving Social Security based on age or upon receiving Social Security for a certified health disability which makes him/her eligible for Social Security.

In one preferred embodiment, the invention comprises the creation and maintenance of an account of any kind known in the art to experts in the field of banking and/or of retirement income. The present invention contemplates that the account may be any form of an account at a bank, brokerage house, an investment company, or a government entity. Preferably it will be a numbered account.

The present invention also comprises the step of inputting into a computer data memory device information about a transaction between a purchaser and a seller of a good or service. This information is inputted into a computer using any method or software that is known or may be devised by an expert in the field of using and devising methods and/or software for inputting information into a computer. In a preferred embodiment, the method comprises a computer program and a money transfer card with a unique number which is keyed into the recipient account, a remote connection from the point of purchase to the seller's transferor account and to the purchaser's transferee account, and method to record one or more of the following (a) data that identify the transferor: name, a unique identifying number (which can be a tax number), address, hour, date, employee number, (b) the amount of the purchase transaction, (c) the amount to be transferred based on the transaction, (d) the transaction number, (e) data that uniquely identify the purchaser to whom the amount will be transferred, which unique identifier may be selected from the group comprising the purchaser's Social Security and an individual's or a corporate entity's tax number, (f) the account number of the purchaser's transferee or recipient account. The method also comprises the step of calculating an transferred amount for the transaction by using a computer data processing device such as one described above. The method further comprises the step of transferring funds equal to the calculated amount from the seller's account (or from a pool created and maintained by the seller) to the purchaser's retirement account. The method also comprises the step of reporting the transferred amount to the purchaser and to the sponsor.

A system or method of the present invention comprises an identification means which identifies a purchaser who participates in a transaction with a seller of a good or service. The identification means can be any tangible item capable of storing information, such as a plastic card with information recorded in a magnetic strip or in some other machine readable form, for example, a credit card or a credit card-like device. The identification means contains identification information describing the identity of the purchaser. The identification information may also include other information such as information describing the identity of the purchaser's retirement account.

The methods and systems of the present invention also include a computer data storage memory device and at least one input device for inputting the transactional information into that computer data storage memory. Input devices may include an electronic card reader, a scanner, a computer keyboard or any other means known to one skilled in the art of inputting information into computer data storage memory devices.

The methods and systems of the present invention also include a software program and a computer data processing device for utilizing the software program. The computer data processing device may be any electronic computer such as personal computer or a work station computer or a main frame computer. The computer data processing device is in communication with the computer data storage memory device in which the transactional information is stored so that the computer data processing device can and does access and utilize the transactional information during the execution of the software program to calculate an amount that is to be transferred to the purchaser's retirement account for the transaction.

The methods and systems of the present invention may also include a pool of funds, such as a bank account, having monetary funds and a means to transfer a portion of the monetary funds of the award pool equal to the award amount from the pool to the purchaser's account. The means for transferring a portion of the monetary funds from the pool to the purchaser's account may be any means known to one skilled in the art for transferring monetary funds between a first monetary account, a monetary store, or a monetary reserve and a second monetary account. One such example is an electronic funds transfer system. An award system of the present invention further comprises a means for reporting the transaction amount and the transferred amount to the purchaser and to the seller. This means of reporting may take a number of forms, including that of a mailed paper report or an electronic report transmitted via the Internet.

The administrator of the account can be a government entity or a private enterprise. In one embodiment, the account is administered as a savings account. The administrator is remunerated from the interest on the monies in the account, and/or from guaranteed transactions. The entity that house and maintains and manages the account cannot speculate with the funds; it may only engage in guaranteed transactions.

It is envisioned that if the host, holder or administrator of the account changes, the unique number of the account may be changed to a different unique number.

The invention further comprises a method for crediting to the account the amount of money that results from the transaction. The business institution will preferably transfer the amount immediately upon every purchase, or the information may be recorded both by the seller and purchaser of the good or service until a certain pre-determined date is reached, at which point the accumulated amount is transferred from the seller's account to the purchaser's account. To ensure that the funds obtained from the purchaser are indeed diligently transferred to his account, the seller preferably immediately transfers that amount from an account maintained by the seller to the purchaser. Alternatively, the seller may temporarily store the funds in an account belonging to the seller, until a predetermined date is reached, such as the beginning and/or middle and/or the end of the month.

In a preferred embodiment, the purchaser may access the funds in the account only upon retirement after reaching the age for receiving Social Security, or for his/her funeral expenses, or upon becoming a certified recipient of Social Security because of a disability. A committee or officer of the administrator of the account would have to certify that the asserted need warrants making the funds in the account available. The funds may be used upon the purchaser's death to pay for the purchaser's funeral expenses.

If the purchaser is a corporate entity with a finite and/or predetermined existence (such as a corporation created for a special purpose, which corporation ceases to exist or becomes inactive once the purpose is accomplished) the funds are transferred to the designated beneficiary (beneficiaries) once the corporation ceases to exist or becomes inactive.

Permanent or indefinite corporations may transfer the account funds to predetermined beneficiaries when a predetermined date arrives.

An account of the present invention will preferably only be funded by purchases made by the original purchaser or by transference of funds from a purchaser's account to the account of a beneficiary.

In an embodiment of the present invention wherein the purchaser is an employer, the general rule is that the funds belong to the individual employer and/or to the owner president and/or shareholders of the corporate employer. In a preferred embodiment, the account into which funds based on purchases are transferred is an account from which the employer provides pension and/or retirement benefits for the purchaser's employees. For example, Employer A as a purchaser, engages in a transaction with Supplier B. As a result of the transaction, the above-described computer causes an amount X to be calculated and causes funds equal to amount X to be transferred into an account which is maintained for the purpose of providing pension and/or retirement benefits to Employer A's employees.

In a preferred embodiment the account is a retirement account whose funds will be used by the purchaser upon his or her retirement. The funds and any interest on the account may be tax-free. Alternatively, the funds may be tax deferred, with taxes payable when the funds in the account are actually used.

The entity that provides at least one good and/or at least one service is selected from the group comprising a for-profit business, a non-profit entity, or a government entity.

The invention further requires making obligatory the calculation and transfer of said amount of money upon the purchase of every good and service, to said destination amount. The calculation and transfer is rendered obligatory by the enactment of a means selected from the group comprising a federal and/or state executive order and/or statute and/or rule and/or judicial order.

The amount of money to be transferred may be a fixed percentage of the cost of the purchase of the good or service. This fixed percentage may be any percentage selected by the seller or the market, which may be include any percentage selected from the range of percentages comprising from 0.01% to 10%, and may preferably be selected from the group comprising 0.5%, 1%, 2%, 3%, 4% and 5%.

The amount of money to be transferred may also be a variable percentage of the transaction. The variable percentage may be specified by a pre-determined formula and/or according to a pre-determined agreement, which may establish different percentages, for example, based on the total amount of the purchase transaction. For example, a higher percent may be used for a higher cost transaction, which would stimulate purchasing greater amounts of goods and/or services.

In addition to the amounts paid by the purchaser of the good or service, the seller may also opt to award a further amount as a percentage of the purchase amount, as described in U.S. Pat. No. 5,991,736, currently expired for failure to pay maintenance fees (whose dispositions are incorporated by reference as prior art). This disposition is not part of this invention but may be used as a voluntary source of funds for the retirement account.

In one embodiment, it is contemplated that when the funds become available, they will preferably not be available as a lump sum, but as a prorated amount. The prorated amount is the amount in the account divided by the number of months of the life expectancy at the moment that benefits begin to be received. The reasonable life expectancy of the recipient of the funds will be calculated based on the average life expectancy at the time at the time the benefits begin to be received.

Preferably, the funds in the account cannot ever be garnished in whole or in part, by a private or public entity, neither before they are received nor while they are received, nor upon the death of the original purchaser.

The invention can be used to detect businesses that charge sales tax but do not report or transmit the tax, and to reduce tax evasion. Since the details of each transaction are recorded, the businesses that charge but do not report any sales tax can readily be detected. For example, in Puerto Rico approximately 44% of sales tax is charged but is neither reported nor paid to the government. This translates to about $900 million in lost revenue which is illegally pocketed by tax-evading businessmen. Thus, the present invention provides a win-win-win for honest businesses, individuals and the government.

While preferred embodiments of the present invention are described herein, it is to be distinctly understood that the present invention is not limited thereto but may be otherwise embodied and practiced within the scope of the following claims, and as may readily be modified in ways obvious to a person of ordinary skill in the art.

What is claimed is:

1. An obligatory method for accumulating an amount of money for retirement or for certified special needs, which comprises automatically and obligatorily transferring an amount of money into an account, which amount of money is determined as a percentage of the amount a purchaser spends on the purchase of least one good and/or and or at least one service, wherein the amount of money is placed in an account for the benefit and use of said purchaser and/or for any designated beneficiary.

2. The obligatory method of claim 1, wherein the system is rendered obligatory by the enactment of at least one municipal and/or state and/or federal executive order and/or rule and/or regulation and/or statute.

3. The method of claim 1, wherein said account is a tax-free account.

4. The method of claim 1, wherein said account is a tax-deferred account.

5. The method of claim 1, wherein said percent is a fixed percent.

6. The method of claim 1, wherein said percent is a fixed percent.

7. The method of claim 6, wherein said percent may be selected from the range of percentages from 0.01% to 10%, and is preferably selected from the group consisting of 0.5%, 1%, 2%, 3%, 4% and 5%.

8. The method of claim 1, wherein said percent is a variable percent.

9. The method of claim 8, wherein said variable percent is determined by a method from the group of methods which comprise specifying the percent by applying a pre-determined formula, and specifying the percent according to a pre-determined method for determining said percent.

10. The method of claim 1, comprising: a money transfer card with a unique number which is keyed into the purchaser's account, a remote connection from the point of purchase to the seller's transferor account and to the purchaser's transferee account, and a method to record (a) data that identify the seller: name, a unique identifying number, address, hour, date, employee number, (b) the amount of the purchase transaction, (c) the amount to be transferred based on the transaction, (d) the transaction number, (e) data that uniquely identify the purchaser to whose account the amount will be transferred, including name or unique identifier, which unique identifier may be selected from the group comprising the purchaser's Social Security and an individual's or a corporate entity's tax number, and (f) the account number of the purchaser's transferee or recipient account.

11. An obligatory system for accumulating an amount of money for retirement or for special needs, which comprises automatically and obligatorily transferring an amount of money into an account, which amount of money is determined as a percentage of the amount a purchaser spends on the purchase of least one good and/or and or at least one service, wherein the amount of money is placed in an account for the benefit and use of said purchaser and/or for any designated beneficiary.
